(19) United States
(12) Patent Application Publication
(10) Pub. No.: US 2026/0023958 A1
(43) Pub. Date: Jan. 22, 2026

(54) ARITHMETIC PROCESSING DEVICE, ARITHMETIC PROCESSING METHODS, AND ARITHMETIC PROCESSING PROGRAM

(71) Applicant: NTT, Inc., Tokyo (JP)

(72) Inventors: Yusuke HORISHITA, Tokyo (JP); Saki HATTA, Tokyo (JP); Daisuke KOBAYASHI, Tokyo (JP); Yuya OMORI, Tokyo (JP); Ken NAKAMURA, Tokyo (JP); Shuhei YOSHIDA, Tokyo (JP); Yuko IINUMA, Tokyo (JP); Hiroyuki UZAWA, Tokyo (JP)

(73) Assignees: NIPPON TELEGRAPH AND TELEPHONE CORPORATION, Tokyo (JP); NTT, Inc., Tokyo (JP)

(21) Appl. No.: 18/878,023

(22) PCT Filed: Jul. 1, 2022
(86) PCT No.: PCT/JP2022/026524

§ 371 Date: Dec. 21, 2024

(51) Int. Cl. G06N 3/063

(52) U.S. Cl. CPC G06N 3/063

(57) ABSTRACT

An arithmetic processing device includes: an arithmetic unit configured to execute an arithmetic operation corresponding to each of layers constituting a neural network and output an arithmetic operation result; an analysis unit configured to perform, for each of division units obtained by dividing the arithmetic operation result by one or more units, an analysis according to the arithmetic operation result belonging to the division unit, and output an analysis result for each division unit; a decimal point position determination unit configured to determine a decimal point position indicating a dynamic range for each division unit on the basis of the analysis result for each division unit output by the analysis unit; and a quantization unit configured to perform quantization on the arithmetic operation result to become fixed-point data having a decimal point position determined for the division unit to which the arithmetic operation result belongs.

### TECHNICAL FIELD

The disclosed technology relates to an arithmetic processing device, an arithmetic processing method, and an arithmetic processing program.

### BACKGROUND ART

Patent Literature 1 describes a technology related to a data processing device that avoids occurrence of significant deterioration in a result of data processing while achieving miniaturization and low power consumption of the device. The data processing device of this technology includes a decimal point position control circuit configured to set a decimal point position of N-bit fixed-length data corresponding to each of a plurality of layers constituting a multilayer neural network. In addition, the data processing device includes an arithmetic processing circuit configured to perform arithmetic processing corresponding to each of the plurality of layers on the N-bit fixed-length data in which the decimal point position is set according to a processing algorithm of the multilayer neural network.

### CITATION LIST

### Patent Literature

Patent Literature 1: International Patent Application Publication No. WO2022/003855

### SUMMARY OF INVENTION

### Technical Problem

In CNN inference processing using fixed-point arithmetic, there is a technology for suppressing a decrease in inference accuracy by dynamically controlling a decimal point position of arithmetic data used for a convolution operation for each input image and each layer and optimizing a value range and decimal precision in which the arithmetic data can be expressed. In the technology, an arithmetic processing result of the CNN is analyzed in units of one frame or one layer, and the decimal point position reflecting the analysis result is applied to the arithmetic processing of the next frame. While it is possible to improve the inference accuracy of the next frame with a simple hardware configuration without using floating-point arithmetic or the like, there are the following problems. First, in a low-frame-rate video, a correlation between frames in a time direction becomes low, and it becomes difficult to improve inference accuracy. Second, a latency for one frame is required to reflect the optimum decimal point position, and in a case where the technology is to be applied to a currently processed frame or a still image, inference processing for two frames is required for the same image. Third, since the decimal point position is controlled for each image or layer, the decimal point position cannot be adaptively controlled in a case where a bias occurs in a necessary value range or decimal precision in a feature map. If the bias occurs, a portion where the deterioration of the arithmetic accuracy becomes larger locally occurs inside the feature map.

The disclosed technology has been made in view of the above points, and an object thereof is to provide an arithmetic processing device, an arithmetic processing method, and an arithmetic processing program capable of optimizing a decimal point position and suppressing deterioration of arithmetic accuracy.

### Solution to Problem

According to a first aspect of the present disclosure, there is provided an arithmetic processing device including: an arithmetic unit configured to execute an arithmetic operation corresponding to each of layers constituting a neural network and output an arithmetic operation result; an analysis unit configured to perform, for each of division units obtained by dividing the arithmetic operation result by one or more units, an analysis according to the arithmetic operation result belonging to the division unit, and output an analysis result for each division unit; a decimal point position determination unit configured to determine a decimal point position indicating a dynamic range for each division unit on the basis of the analysis result for each division unit output by the analysis unit; and a quantization unit configured to perform quantization on the arithmetic operation result to become fixed-point data having a decimal point position determined for the division unit to which the arithmetic operation result belongs.

According to a second aspect of the present disclosure, there is provided an arithmetic processing method executed by a computer, the arithmetic processing method including: executing an arithmetic operation corresponding to each of layers constituting a neural network and outputting an arithmetic operation result; performing, for each of division units obtained by dividing the arithmetic operation result by one or more units, an analysis according to the arithmetic operation result belonging to the division unit, and outputting an analysis result for each division unit; determining a decimal point position indicating a dynamic range for each division unit on the basis of the output analysis result for each division unit; and performing quantization on the arithmetic operation result to become fixed-point data having a decimal point position determined for the division unit to which the arithmetic operation result belongs.

According to a third aspect of the present disclosure, there is provided an arithmetic processing program causing a computer to execute processing of: executing an arithmetic operation corresponding to each of layers constituting a neural network and outputting an arithmetic operation result; performing, for each of division units obtained by dividing the arithmetic operation result by one or more units, an analysis according to the arithmetic operation result belonging to the division unit, and outputting an analysis result for each division unit; determining a decimal point position indicating a dynamic range for each division unit on the basis of the output analysis result for each division unit; and performing quantization on the arithmetic operation result to become fixed-point data having a decimal point position determined for the division unit to which the arithmetic operation result belongs.

### Advantageous Effects of Invention

According to the disclosed technology, it is possible to optimize a decimal point position and to suppress deterioration of arithmetic accuracy.

### BRIEF DESCRIPTION OF DRAWINGS

FIG. 1 is a block diagram illustrating a hardware configuration of an object detection device according to an embodiment.

FIG. 2 illustrates an example of a layer structure of a convolutional neural network for implementing object detection processing.

FIG. 3 is a diagram illustrating an internal structure of a feature map in the present embodiment.

FIG. 4 is a block diagram illustrating an example of a hardware configuration of an accelerator in the present embodiment.

FIG. 5A illustrates a case where a size of a decimal point position control unit is set to 4×4, an operation target block size of a PE is set to 6×6, and each PE executes convolution operation processing of padding 1 and stride 1 using a 3×3 kernel.

FIG. 5B illustrates a case where each PE executes convolution operation processing of padding 1 and stride 2 on a feature map output illustrated in FIG. 5A using a 3×3 kernel.

FIG. 5C illustrates a case where each PE executes convolution operation processing of padding 1 and stride 1 on a feature map output illustrated in FIG. 5B using a 3×3 kernel.

FIG. 6 is a block diagram illustrating an example of a hardware configuration of the PE.

FIG. 7 is a block diagram illustrating an example of a hardware configuration of an arithmetic unit.

FIG. 8 is a diagram illustrating an example of a hardware configuration for performing digit alignment of arithmetic data in which a plurality of decimal point positions are mixed.

FIG. 9A illustrates an example of analysis in which an analysis unit in the present embodiment uses four types of decimal point positions.

FIG. 9B illustrates an example of an analysis result of the analysis unit.

FIG. 10 is a flowchart illustrating a flow of arithmetic processing in the PE.

FIG. 11 is a block diagram illustrating an example of a hardware configuration of a PE in a second embodiment.

FIG. 12 illustrates a reference relationship of a feature map analysis result.

FIG. 13 illustrates an example of a decimal point position determination method by a decimal point position determination unit with respect to an analysis result of a feature map.

### DESCRIPTION OF EMBODIMENTS

An example of an embodiment of the disclosed technique will be described below with reference to the drawings. In the drawings, the same or equivalent components and portions are denoted by the same reference signs. Further, dimensional ratios in the drawings are exaggerated for convenience of description and thus may be different from actual ratios.

First, an outline and a technology as a premise of the technology of the present disclosure will be described. There is an increasing need for deep learning, and application to various fields such as automated driving and monitoring is expected. In particular, in recent years, dedicated hardware accelerators have been actively developed in order to enable large-scale arithmetic processing of deep learning in an edge terminal such as a camera. In a case where deep learning arithmetic processing is performed by software, data handled in the arithmetic processing is generally 32-bit floating-point data. On the other hand, in a hardware accelerator dedicated to deep learning, data handled in arithmetic processing is often limited to fixed-point data such as 8 to 16 bits. This is to reduce the chip area of the hardware accelerator and improve power performance.

The fixed-point data has a narrow dynamic range that can be compared with the floating-point data, and the arithmetic accuracy may be deteriorated as compared with the case of using the floating-point data. To solve this problem, Patent Literature 1 discloses a method for dynamically controlling a decimal point position of fixed-point data for each layer constituting a neural network. In this method, a counter measures the number of times of occurrence of overflow in which the intermediate arithmetic operation result for each layer constituting the neural network exceeds the upper limit or the lower limit of the dynamic range of the fixed-point data. Then, in the method, the decimal point position is adjusted on the basis of the counter value so as not to cause an overflow at the time of next arithmetic operation execution. Accordingly, the dynamic range of the fixed-point data can be dynamically changed in accordance with the tendency of the arithmetic operation result, and deterioration of arithmetic accuracy can be suppressed even in a case where the fixed-point data is used. However, this method has the problems listed above.

In the technology of the present embodiment, by making it possible to adaptively change the decimal point position within the feature map, it is possible to reflect the optimum decimal point position with lower latency than in the related art, and deterioration of arithmetic accuracy is suppressed. In addition, improvement of inference accuracy by reduction of a quantization error can be expected.

Hereinafter, a configuration of the present embodiment will be described.

### First Embodiment

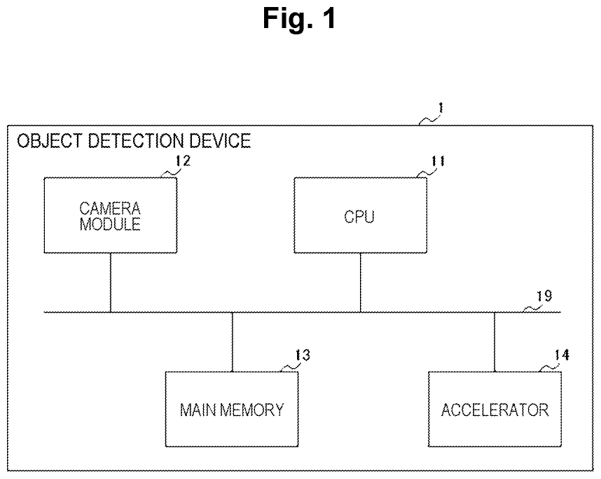

FIG. 1 is a block diagram illustrating a hardware configuration of an object detection device 1 according to the present embodiment. The object detection device 1 includes a central processing unit (CPU) 11, a camera module 12, a main memory 13, and an accelerator 14, which are connected via a system bus 19. The camera module 12 is capable of capturing a still image or a moving image at a predetermined frame rate, and sequentially stores the captured image data in the main memory 13. The main memory 13 is a work memory necessary for software processing of the CPU 11, and stores image data captured by the camera module 12, parameters necessary for execution of the accelerator 14, an arithmetic operation result output by the accelerator 14, and the like. An arithmetic processing program is stored in the main memory 13. The CPU 11 is responsible for controlling the entire object detection device 1, and controls an execution timing of the camera module 12 and the accelerator 14, for example. The accelerator 14 reads image data stored in the main memory 13, and executes object detection processing using a convolutional neural network on the read image data.

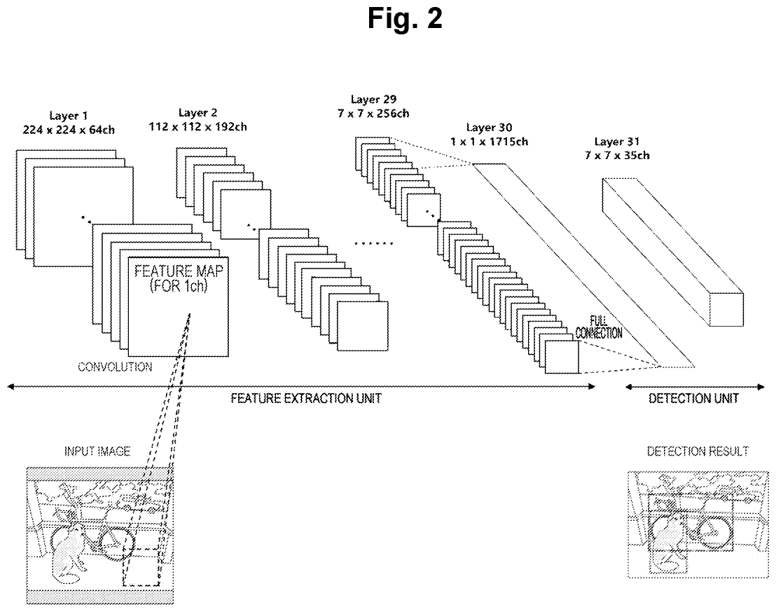

An example of object detection processing executed by the accelerator 14 will be described with reference to FIG. 2. FIG. 2 illustrates an example of a layer structure of a convolutional neural network for implementing object detection processing. In the example illustrated in FIG. 2, the input image is an image including three color components of RGB with a width of 448 pixels and a height of 448 pixels. In a feature extraction unit, convolution operation processing using a plurality of different kernels in each layer, pooling operation processing, or the like is executed on the input image, and a feature map for 1 ch is generated. Thereafter, in a detection unit, full connection is performed on the feature map to generate data of the final layer. In the case of the object detection processing, the data of the final layer includes coordinate information indicating the relative position of the object with respect to the input image, a reliability indicating whether or not the object exists in the coordinates, a class classification probability, or the like. The class classification probability is a probability indicating to which class the object belongs (whether it is a person, a car, a dog, a cat, or the like). With reference to this information, the CPU 11 can detect what kind of object exists at what kind of position in the input image.

In the present embodiment, the individual feature amounts constituting the feature map and the parameter values such as the kernel and the bias used at the time of the convolution operation are 8-bit fixed-point data. Accordingly, the circuit scale of the accelerator and the required capacity of the main memory 13 can be greatly reduced as compared with the case of handling 32-bit floating-point data or the like.

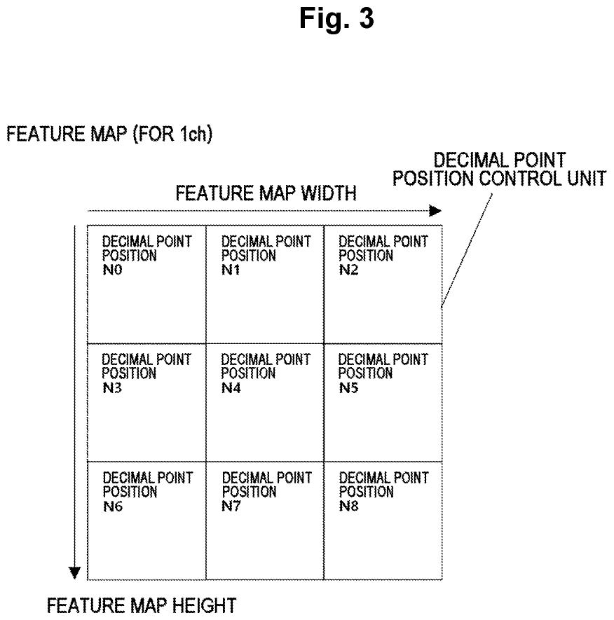

FIG. 3 is a diagram illustrating an internal structure of the feature map in the present embodiment. In the present embodiment, the feature map is divided into a plurality of spatially different units, and the divided units have different decimal point position information (hereinafter, the divided unit will be referred to as a decimal point position control unit (or block)). In the present embodiment, the size of the decimal point position control unit is assumed to be 4 in width and 4 in height (hereinafter referred to as 4×4). The decimal point position control unit can have any size such as 32×32, 8×8, 8×4, or 4×1, and can have any shape such as a square or a rectangle. Furthermore, the size and shape of the decimal point position control unit do not necessarily have to be common to all layers, and can be changed according to the size of the feature map of each layer and the setting of the kernel size, padding, stride, and the like applied to the convolution operation. In this way, the feature map is divided into blocks in the spatial size of the feature map, and a block that is a division unit can have information on a plurality of decimal point positions. Note that the feature map is an example of an arithmetic operation result of the present disclosure. In addition, the decimal point position control unit is a block obtained by dividing the spatial size of the feature map. A block is an example of a division unit of the present disclosure. Hereinafter, a 3×3 block is assumed.

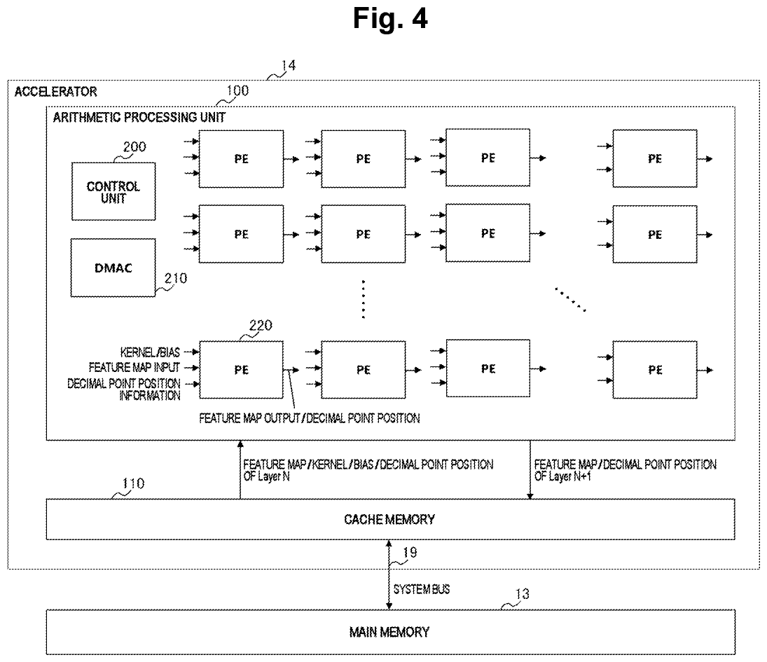

FIG. 4 is a block diagram illustrating an example of a hardware configuration of the accelerator 14 in the present embodiment. The accelerator 14 includes an arithmetic processing unit 100 and a cache memory 110. Note that the arithmetic processing unit 100 is an example of an arithmetic processing device of the present disclosure.

The cache memory 110 is connected to the main memory 13 via the system bus 19. The cache memory 110 serves as a buffer located between the arithmetic processing unit 100 and the main memory 13, and plays a role of reducing a data transfer band between the arithmetic processing unit 100 and the main memory 13. The arithmetic processing unit 100 includes a control unit 200, a DMAC 210, and a plurality of processing engines (PEs) 220 (hereinafter, reference numerals for DMAC and PE will be omitted). The control unit 200 sets operation parameters for the DMAC and each PE, and manages data to be supplied to each PE. The DMAC reads the feature map, the kernel necessary for the convolution operation, the parameter such as the bias, and the decimal point position information within the feature map from the cache memory 110 according to the operation parameter set by the control unit 200. The read data is supplied to each PE, and each PE executes arithmetic processing in parallel. The feature map generated by the arithmetic processing by the PE and the decimal point position information within the feature map are stored in the cache memory 110 via the DMAC, and are read from the cache memory 110 again at the time of the arithmetic processing of the next layer.

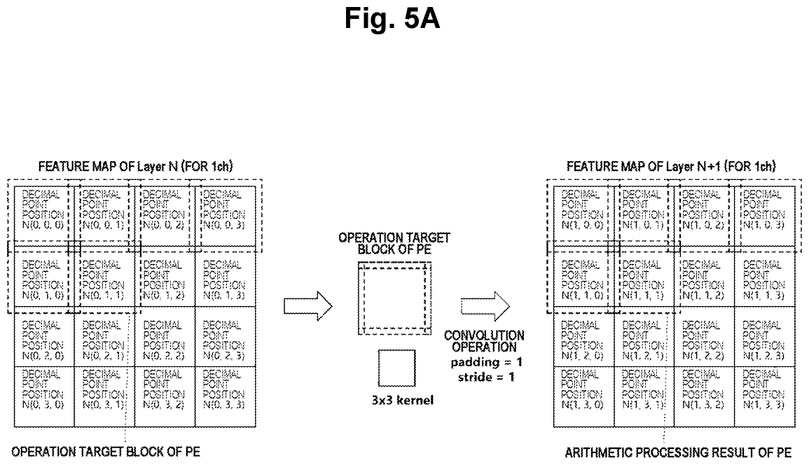

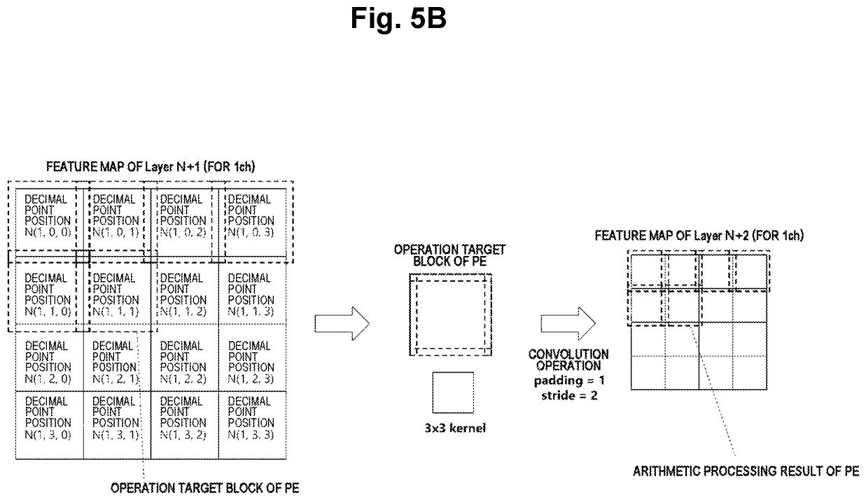

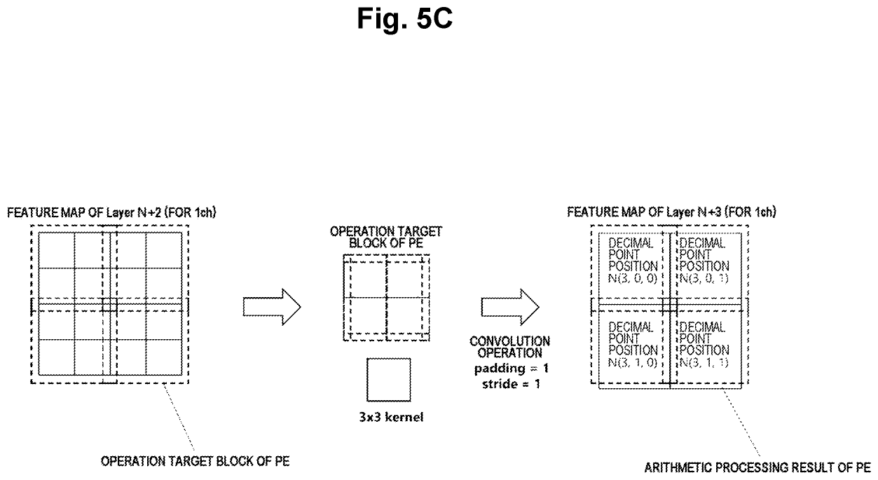

FIG. 5 is a diagram illustrating a relationship between an arithmetic processing unit and a decimal point position control unit of each PE. As indicated by a dotted line frame in FIG. 5, each PE executes convolution operation processing on the feature map in a predetermined block unit. FIG. 5A illustrates a case where the size of the decimal point position control unit is set to 4×4, the operation target block size of the PE is set to 6×6, and each PE executes convolution operation processing of padding 1 and stride 1 using a 3×3 kernel. In this case, nine types of different decimal point positions are mixed in the operation target block of each PE, and thus, it is necessary to supply nine types of decimal point position information to each PE. Each PE executes decimal point position alignment of the convolution operation processing result using the supplied nine types of decimal point position information, integrates the decimal point positions into one, and outputs the integrated result. Note that the decimal point position indicates a dynamic range of data. The selection and output of the decimal point position using the decimal point position information here means that the dynamic range of the data of the PE is determined.

FIG. 5B illustrates a case where each PE executes convolution operation processing of padding 1 and stride 2 on the feature map output illustrated in FIG. 5A using a 3×3 kernel. Similarly to FIG. 5A, nine types of different decimal point position information from each other are mixed in the operation target block of each PE, and thus, it is necessary to supply nine types of decimal point position information to each PE. Each PE executes decimal point position alignment of the convolution operation processing result using the supplied nine types of decimal point position information, integrates the decimal point positions into one, and outputs the integrated result. In the case of FIG. 5B, the feature map width and height are half the size of the input because of stride 2, and thus, the size of the decimal point position control unit within the feature map is also half the size of the input.

FIG. 5C illustrates a case where each PE executes convolution operation processing of padding 1 and stride 1 on the feature map output illustrated in FIG. 5B using a 3×3 kernel. In this case, 16 types of different decimal point position information are mixed in the operation target block of each PE, and thus, it is necessary to supply 16 types of decimal point position information to each PE. Each PE executes decimal point position alignment of the convolution operation processing result using the supplied 16 types of decimal point position information, integrates the decimal point positions into one, and outputs the integrated result.

As described above, each PE executes the convolution operation processing of a predetermined padding and a predetermined stride on the feature map output using a kernel of a predetermined size. Here, considering the case of using floating-point data, 6×6=36 types of decimal point position information (exponents) are mixed inside the operation target block of each PE in any case of FIGS. 5A to 5C. A maximum of four types of a plurality of decimal point positions are mixed within a 3×3 feature map (one block). In this way, a block that is a division unit has a plurality of decimal point positions. On the other hand, nine types of decimal point position information are required in the case illustrated in FIGS. 5A and 5B, and 16 types of decimal point position information are required in the case illustrated in FIG. 5C. Therefore, by dividing the inside of the feature map into units of predetermined blocks and controlling the decimal point position in each unit as in the present embodiment, it is possible to greatly reduce the decimal point position information required for the arithmetic operation as compared with the case of using the floating-point data.

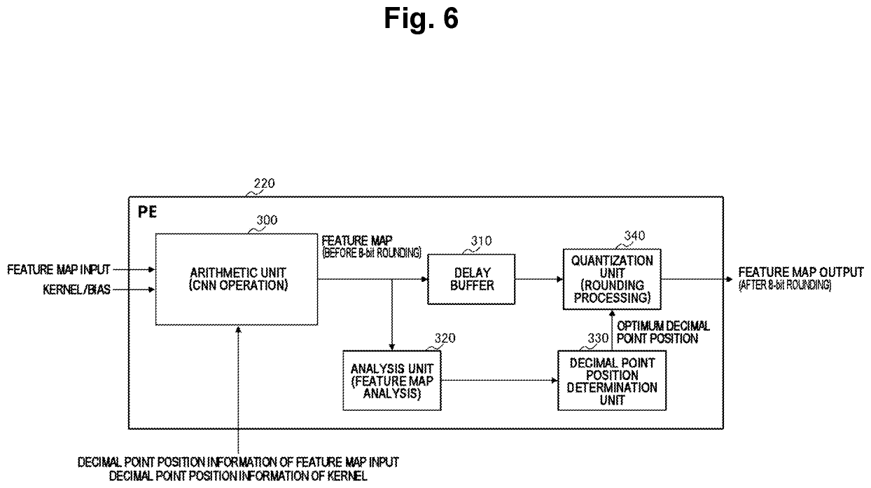

FIG. 6 is a block diagram illustrating an example of a hardware configuration of the PE. The PE in the arithmetic processing unit 100 includes an arithmetic unit 300, a delay buffer 310, an analysis unit 320, a decimal point position determination unit 330, and a quantization unit 340. The functional processing of each unit of the PE will be described below.

The arithmetic unit 300 performs a CNN operation. The arithmetic unit 300 executes a convolution operation using the input feature map and kernel, and executes arithmetic processing such as bias addition and activation function processing on the convolution operation result. The arithmetic unit 300 executes an arithmetic operation corresponding to each layer constituting the neural network through processing described in detail below, and outputs a feature map as an arithmetic operation result.

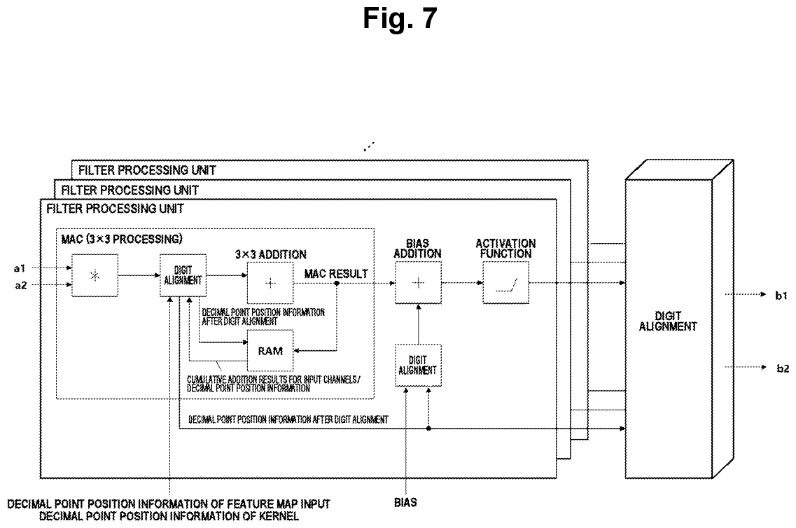

Here, an example of the hardware configuration of the arithmetic unit 300 will be described with reference to FIG. 7. The arithmetic unit 300 includes a plurality of filter processing units corresponding to the operation target block size of the PE, and each filter processing unit performs a maximum of 3×3 convolution operations, bias addition, and activation function processing, and outputs one feature amount as the arithmetic operation result. In the input, a1 is a feature map input (3×3), and a2 is a kernel (3×3). In the output, b1 is a feature map output, and b2 is decimal point position information. The feature map and the kernel input to each filter processing unit are multiplied by a 3×3 multiplier. After the 3×3 multiplication results are subjected to digit alignment processing for the decimal point position, they are all added together with cumulative addition results for input channels, and are output to the subsequent stage as product-sum operation results. The product-sum operation result is also stored in the RAM, and is cumulatively added with the 3×3 multiplication result in the next input channel.

Here, the decimal point position of the 3×3 feature map input to the filter processing unit will be considered with reference to FIG. 5. In any case of FIGS. 5A to 5C, there is a likelihood that a maximum of four types of decimal point positions are mixed in the 3×3 feature map. In addition, there is a likelihood that the cumulative addition results for the input channels stored in the RAM have a decimal point position different from the feature map input to the filter processing unit.

Therefore, the filter processing unit performs the digit alignment of these decimal point positions before executing the 3×3 addition, and outputs the decimal point position information after the digit alignment to the subsequent stage. The decimal point position information after the digit alignment is also referred to at the time of bias addition.

The feature amounts output from the respective filter processing units are subjected to the digit alignment again in the digit alignment processing unit located at the subsequent stage of the filter processing unit, and the decimal point positions within the operation target block of the PE are integrated into one. Then, all the feature amounts and the decimal point position information subjected to the digit alignment are output from the arithmetic unit 300.

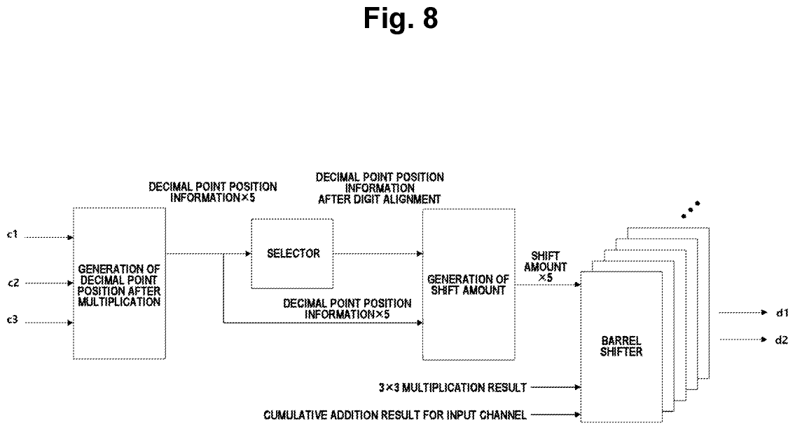

FIG. 8 is a diagram illustrating an example of a hardware configuration for performing digit alignment of arithmetic data in which a plurality of decimal point positions are mixed. In particular, FIG. 8 illustrates, as an example, a 3×3 feature map having a maximum of four types of decimal point positions and digit alignment of decimal point position information of a cumulative addition result for an input channel. In the input, c1 is decimal point position information of the feature map input (a maximum of four types), c2 is decimal point position information of the kernel, and c3 is decimal point position information of the cumulative addition result for the input channel. In the output, d1 is a 3×3 multiplication result (after digit alignment), and d2 is a cumulative addition result (after digit alignment) for the input channel. First, the decimal point position after multiplication by 3×3 is generated from the decimal point position information of the feature map input and the decimal point position information of the kernel. As a result, a maximum of five types of decimal point position information are generated together with the decimal point position information of the cumulative addition result for the input channel. One decimal point position is selected from among these five types of decimal point position information as the decimal point position after the digit alignment. As a method of selecting a decimal point position, various methods such as a method having the highest integer precision or a method having the highest decimal precision in fixed-point data can be considered. Thereafter, the shift amount of the fixed-point data is generated so that a maximum of five types of decimal point positions are all aligned. Further, the feature map input and the cumulative addition result for the input channel are shifted by the generated shift amount and output by the barrel shifter.

Although the example of the hardware configuration of the arithmetic unit 300 has been described above, processing after the arithmetic unit 300 will be described again with reference to FIG. 6. The feature map output from the arithmetic unit 300 is input to the delay buffer 310 and the analysis unit 320. The delay buffer 310 holds the feature map as the arithmetic operation result output from the arithmetic unit 300 until an optimum decimal point position, which will be described later, is determined.

The analysis unit 320 is a processing unit that performs analysis according to the arithmetic operation result belonging to the division unit for each division unit divided in one or more units with respect to the feature map that is the arithmetic operation result, and outputs the analysis result for each division unit. The analysis unit 320 attempts quantization and rounding to the target bit width of fixed-point data at a plurality of predetermined decimal point positions, and counts the number of times the data after quantization and rounding overflows for each decimal point position. Note that the plurality of decimal point positions are an example of a division unit of the present disclosure, and the number of times of overflow counted for each decimal point position is an example of an arithmetic operation result belonging to the division unit of the present disclosure.

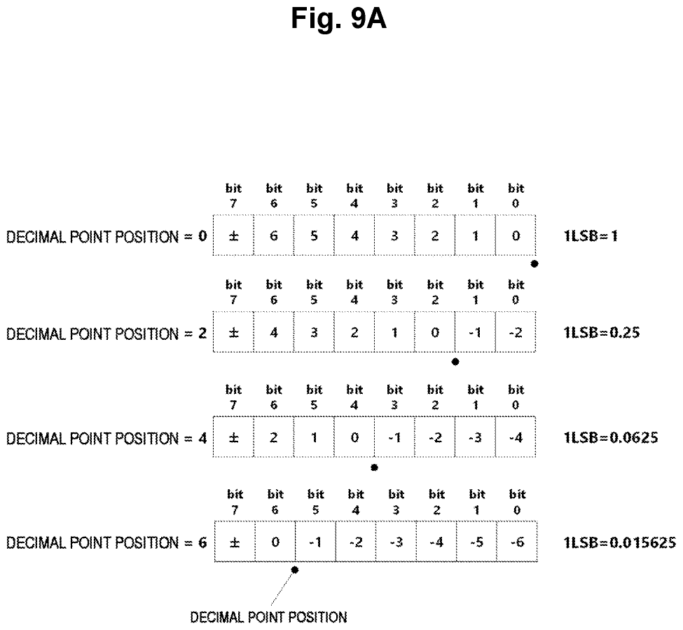

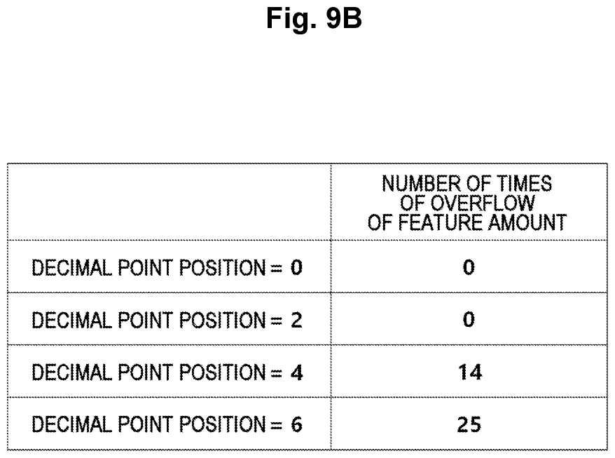

Here, a processing example of the analysis unit 320 will be described with reference to FIG. 9. In FIG. 9, in a case where the decimal point position=N, it is assumed that the LSB of the fixed-point data can express 2\hat{ }(−N). As illustrated in FIG. 9A, the analysis unit 320 in the present embodiment performs quantization and rounding on the feature amount output from the arithmetic unit 300 using four types of decimal point positions, and counts the number of times the data after quantization and rounding overflows for each decimal point position. Various methods are conceivable as the analysis method executed by the analysis unit 320, and in addition to the method described in the present embodiment, a method of cumulatively adding quantization errors when quantization and rounding is performed at each decimal point position, a mean squared error (MSE), a root mean squared error (RMSE), an SN ratio, or the like may be calculated. FIG. 9B illustrates an example of an analysis result of the analysis unit 320. As the decimal point position is shifted to the left, the decimal precision becomes higher, but the likelihood of overflow due to quantization and rounding becomes higher, and thus overflow occurs after the decimal point position=4. Here, the processing of the decimal point position determination unit 330 will be described again with reference to FIG. 6.

The decimal point position determination unit 330 determines the decimal point position for each block that is a division unit on the basis of the plurality of analysis results for each division unit output by the analysis unit 320. With reference to the analysis result of the analysis unit 320, an optimum decimal point position is selected and output from among a plurality of predetermined decimal point positions. The decimal point position determination unit 330 in the present embodiment refers to the number of times of overflow due to quantization and rounding of each decimal point position obtained from the analysis unit 320, and selects one having the smallest number of times of overflow and the highest decimal precision. In the example illustrated in FIG. 9, the decimal point position determination unit 330 determines the decimal point position=2 as the optimum decimal point position.

The quantization unit 340 performs quantization on the feature map to become fixed-point data having the decimal point position determined for the division unit to which the feature map belongs. The quantization unit 340 refers to the feature map before quantization and rounding held in the delay buffer 310, performs quantization and rounding according to the optimum decimal point position determined by the decimal point position determination unit 330, and outputs the feature map after quantization and rounding.

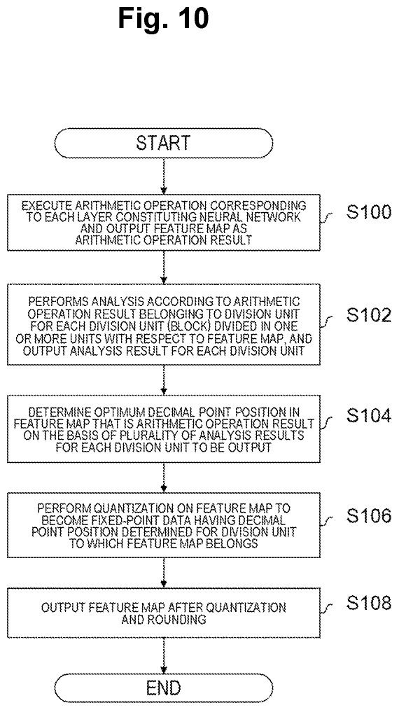

Next, an operation in the PE of the arithmetic processing unit 100 will be described. FIG. 10 is a flowchart illustrating a flow of arithmetic processing in the PE. The CPU 11 reads the arithmetic processing program from the main memory 13, develops the program in the cache memory 110, and executes the arithmetic processing by each unit of the PE.

In step S100, the arithmetic unit 300 executes an arithmetic operation corresponding to each layer constituting the neural network and outputs a feature map as an arithmetic operation result. The feature map output here is held as an arithmetic operation result in the delay buffer 310 until the optimum decimal point position is determined.

In step S102, the analysis unit 320 performs analysis according to the arithmetic operation result belonging to the division unit for each division unit (block) divided in one or more units with respect to the feature map that is the arithmetic operation result, and outputs the analysis result for each division unit. The division unit is a block of a plurality of decimal point positions. The analysis result is the number of times of overflow counted for each decimal point position.

In step S104, the analysis unit 320 causes the decimal point position determination unit 330 to determine the optimum decimal point position for each block that is a division unit on the basis of the plurality of analysis results for each division unit to be output.

In step S106, the quantization unit 340 performs quantization on the feature map to become fixed-point data having the decimal point position determined for the division unit to which the feature map belongs.

In step S108, the arithmetic processing unit 100 outputs the feature map after quantization and rounding. As described above, according to the present embodiment, it is possible to optimize a decimal point position and to suppress deterioration of arithmetic accuracy.

### Second Embodiment

In the PE of the first embodiment, the feature map before quantization and rounding has been held in the delay buffer 310 until the optimum decimal point position is determined by the processing of the analysis unit 320 and the decimal point position determination unit 330. While quantization processing using an optimum decimal point position for the feature map has been possible, hardware such as a delay buffer has been required. In a PE of a second embodiment, a target decimal point position is determined by referring to a result spatially adjacent within the feature map and already analyzed. Since the target decimal point position can be determined without waiting for completion of analysis of the feature map, the delay buffer for holding the feature map can be reduced.

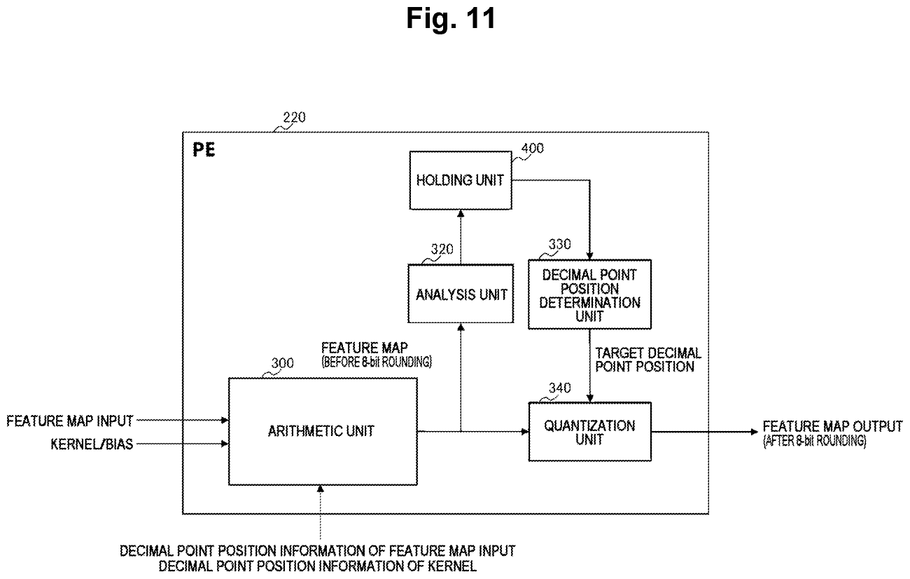

FIG. 11 is a block diagram illustrating an example of a hardware configuration of the PE in the second embodiment. Unlike the first embodiment, in the second embodiment, a delay buffer 310 for holding the feature map before quantization and rounding is not provided. In addition, each PE has a holding unit 400 for holding an analysis result of the feature map. Since the holding unit 400 only needs to hold several analysis results for one operation target block, the circuit scale can be reduced as compared with the delay buffer that holds all the feature map outputs of the operation target block. In this way, by further including the holding unit 400 configured to hold the feature map that is the arithmetic operation result output from the arithmetic unit 300, the holding unit 400 can output, after a decimal point position is determined for a division unit to which an arithmetic operation result to be held belongs, the arithmetic operation result.

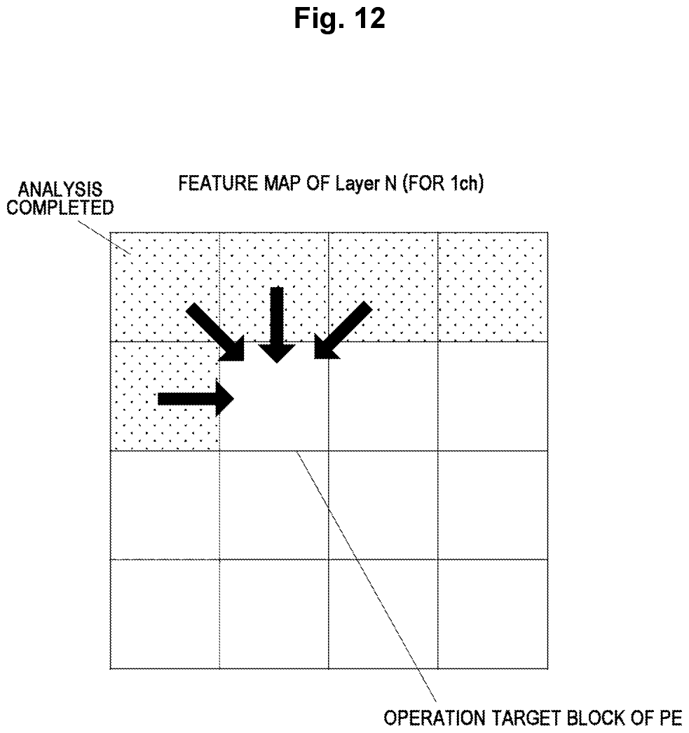

FIG. 12 illustrates a reference relationship of the feature map analysis result. In FIG. 12, the blocks of the dot pattern are blocks for which the convolution operation by the PE and the analysis of the feature map have already been completed. In addition, the feature map analysis results of these blocks are stored in the holding unit 400 of the analysis results illustrated in FIG. 11. The PE in the present embodiment refers to the feature map analysis results of the blocks adjacent to the upper left, upper, upper right, and left of the operation target block and determines the target decimal point position. In addition, various methods such as referring only to the feature map analysis result of the block adjacent to the left are conceivable, and the required capacity of the holding unit 400 becomes smaller as the number of blocks to be referred to is smaller.

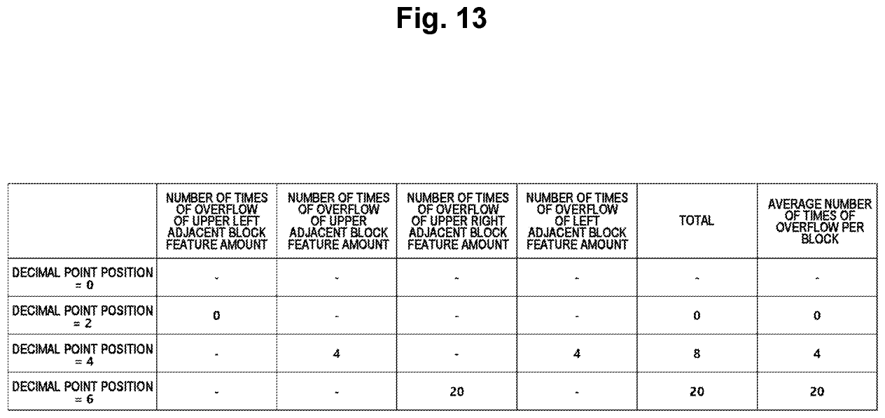

FIG. 13 illustrates an example of a decimal point position determination method by the decimal point position determination unit 330 with respect to the analysis result of the feature map. FIG. 13 illustrates that the decimal point position=2 is employed as the target decimal point position for the upper left adjacent block, and as a result, the number of times of overflow of the feature amount by quantization and rounding is 0. Similarly, the target decimal point positions employed for the upper adjacent block, the upper right adjacent block, and the left adjacent block, and the number of times of overflow of the feature amounts obtained as a result thereof are illustrated. For example, the decimal point position determination unit 330 in the present embodiment calculates the average number of times of overflow per block from these results, and selects the decimal point position having the highest decimal precision from among the decimal point positions where the average number of times of overflow is 10 or less. In FIG. 12, since the average number of times of overflow is 10 or less and the decimal point position having the highest decimal precision is the decimal point position=4, the decimal point position determination unit 330 outputs the decimal point position=4 as the target decimal point position. In order to obtain the target decimal point position, the feature map before the quantization and rounding output from the arithmetic unit 300 is subjected to the quantization and rounding processing to become the fixed-point data having the target decimal point position, and is output. In this way, the decimal point position determination unit 330 can determine the decimal point position of the division unit on the basis of the analysis results of one or more division units spatially adjacent to the division unit.

The arithmetic processing, which is executed by the CPU reading software (program) in each embodiment described above, may be executed by various processors other than the CPU. Examples of the processors in this case include a programmable logic device (PLD) whose circuit configuration can be changed after the manufacturing, such as a field-programmable gate array (FPGA), and a dedicated electric circuit that is a processor having a circuit configuration exclusively designed for executing specific processing, such as a graphics processing unit (GPU) and an application specific integrated circuit (ASIC). In addition, the arithmetic processing may be performed by one of these various processors, or may be performed by a combination of two or more processors of the same type or different types (for example, a plurality of FPGAs, a combination of a CPU and an FPGA, and the like). More specifically, a hardware structure of the various processors is an electric circuit in which circuit elements such as semiconductor elements are combined.

Further, in each embodiment described above, the aspect in which the program (arithmetic processing program) are stored (installed) in advance in the main memory 13 has been described, but the present disclosure is not limited thereto. The program may be provided by being stored in a non-transitory storage medium such as a compact disk read only memory (CD-ROM), a digital versatile disk read only memory (DVD-ROM), and a Universal Serial Bus (USB) memory. Further, the program may be downloaded from an external device via a network.

Regarding the above embodiment, the following supplementary notes are further disclosed.

### (Supplementary Note 1)

An arithmetic processing device including:
a memory; and
at least one processor connected to the memory,
in which the processor is configured to:
execute an arithmetic operation corresponding to each of layers constituting a neural network and output an arithmetic operation result;
perform, for each of division units obtained by dividing the arithmetic operation result by one or more units, an analysis according to the arithmetic operation result belonging to the division unit, and output an analysis result for each division unit;
determine a decimal point position for each division unit on the basis of the output analysis result for each division unit; and
perform quantization on the arithmetic operation result to become fixed-point data having a decimal point position determined for the division unit to which the arithmetic operation result belongs.

### (Supplementary Note 2)

A non-transitory storage medium having a program stored therein, the program executable by a computer to execute arithmetic processing of:
executing an arithmetic operation corresponding to each of layers constituting a neural network and outputting an arithmetic operation result;
performing, for each of division units obtained by dividing the arithmetic operation result by one or more units, an analysis according to the arithmetic operation result belonging to the division unit, and outputting an analysis result for each division unit;
determining a decimal point position for each division unit on the basis of the output analysis result for each division unit; and
performing quantization on the arithmetic operation result to become fixed-point data having a decimal point position determined for the division unit to which the arithmetic operation result belongs.

1. An arithmetic processing device comprising:
a memory; and
at least one processor coupled to the memory, the at least one processor being configured to:
configured to execute an arithmetic operation corresponding to each of layers constituting a neural network and output an arithmetic operation result;
configured to perform, for each of division units obtained by dividing the arithmetic operation result by one or more units, an analysis according to the arithmetic operation result belonging to the division unit, and output an analysis result for each division unit;
configured to determine a decimal point position indicating a dynamic range for each division unit on the basis of the analysis result for each division unit output; and
configured to perform quantization on the arithmetic operation result to become fixed-point data having a decimal point position determined for the division unit to which the arithmetic operation result belongs.

2. The arithmetic processing device according to claim 1, further comprising the processor is configured to hold an arithmetic operation result output,
wherein the processor is outputs, after a decimal point position is determined for a division unit to which an arithmetic operation result to be held belongs, the arithmetic operation result.

3. The arithmetic processing device according to claim 1, wherein the processor is configured to determines the decimal point position of the division unit on the basis of analysis results of one or more division units spatially adjacent to the division unit.

4. The arithmetic processing device according to claim 1, wherein the arithmetic operation result is used as a feature map, and blocks obtained by dividing a spatial size of the feature map are used as the division units.

5. The arithmetic processing device according to claim 1, wherein a plurality of decimal point positions are included in the division unit by using the arithmetic operation result as a feature map and performing convolution operation processing with a predetermined padding and a predetermined stride using a kernel of a predetermined size in the arithmetic operation,
the analysis counts, for each division unit, the number of times of overflow in the arithmetic operation result among the plurality of decimal point positions, and
sets, for each division unit, a decimal point position having a smallest number of times of overflow and highest decimal precision as a decimal point position of the division unit.

6. An arithmetic processing method executed by a computer, the arithmetic processing method comprising:
executing an arithmetic operation corresponding to each of layers constituting a neural network and outputting an arithmetic operation result;
performing, for each of division units obtained by dividing the arithmetic operation result by one or more units, an analysis according to the arithmetic operation result belonging to the division unit, and outputting an analysis result for each division unit;
determining a decimal point position indicating a dynamic range for each division unit on the basis of the output analysis result for each division unit; and
performing quantization on the arithmetic operation result to become fixed-point data having a decimal point position determined for the division unit to which the arithmetic operation result belongs.

7. A non-transitory, computer-readable storage medium storing an arithmetic processing program causing a computer to execute processing of:
executing an arithmetic operation corresponding to each of layers constituting a neural network and outputting an arithmetic operation result;
performing, for each of division units obtained by dividing the arithmetic operation result by one or more units, an analysis according to the arithmetic operation result belonging to the division unit, and outputting an analysis result indicating a dynamic range for each division unit;
determining a decimal point position for each division unit on the basis of the output analysis result for each division unit; and
performing quantization on the arithmetic operation result to become fixed-point data having a decimal point position determined for the division unit to which the arithmetic operation result belongs.
